(19) United States
(12) Patent Application Publication
(10) Pub. No.: US 2016/0267724 A1
(43) Pub. Date: Sep. 15, 2016

(54) SYSTEM AND METHOD USING WIRELESS TIRE PRESSURE DETECTOR TO TRANSMIT DATA AND FORM NETWORK TOPOLOGY

(71) Applicant: GOFULL TECHNOLOGY CO., LTD., HSINCHU CITY 30062 (TW)

(72) Inventors: CHI-KANG LIU, HSINCHU CITY 30062 (TW); CHEN-CHIH HUANG, HSINCHU COUNTY 31061 (TW); YUN-HUNG SHEN, HSINCHU CITY 30080 (TW)

(21) Appl. No.: 14/722,226

(22) Filed: May 27, 2015

(30) Foreign Application Priority Data
Mar. 13, 2015 (TW) 104108165

(51) Int. Cl. G07C 5/00; B60C 23/00; G01S 19/13; B60K 35/00

(52) U.S. Cl. CPC G07C 5/008; B60K 35/00; B60C 23/00; G01S 19/13; H04W 84/18

(57) ABSTRACT

A system and method using a wireless tire pressure detector to transmit data and form a network topology is disclosed herein. The method comprises steps: installing a wireless tire pressure detector in a receiver, and a sender persistently transmitting at least one piece of broadcast information; while the receiver approaches the sender, the wireless tire pressure detector of the receiver using a first transmission module to receive the broadcast information, send the broadcast information to a display device in a vehicle or store the broadcast information in a cloud database, and send the broadcast information to a second transmission module, and using the second transmission module to send the broadcast information to a wireless tire pressure detector of another vehicle, wherein the display device uses an application program to process and display the broadcast information, and wherein the display device includes a video device and an audio device.

This application claims priority for Taiwan patent application no. 104108165 filed on Mar. 13, 2015, the content of which is incorporated by reference in its entirely.

### BACKGROUND OF THE INVENTION

1. Field of the Invention

The present invention relates to a technology for transmitting data and forming a network topology, particularly to a system and method using a wireless tire pressure detector to transmit data and form a network topology.

2. Description of the Related Art

At present, manufacturers are developing a second advertisement mode, wherein advertisements are directly transmitted to an approaching mobile device. In the application, the user has to turn on the GPS system or the Bluetooth function of the mobile device. While the GPS system shows the current position of the mobile device, the advertisements of the nearby shops will be presented on the screen of the mobile device. Alternatively, the shop is equipped with a Bluetooth transmitter, such as iBeacon, and the Bluetooth transmitter will transmit advertisements to the nearby mobile devices whose Bluetooth devices are turned on.

If the Bluetooth function of a mobile device is not turned on, the mobile device would not receive advertisements. However, while the GPS system of a mobile device is turned on, the privacy of the user is leaked. Besides, advertisements from an iBeacon device can only be received by the mobile devices having the corresponding iBeacon application program. Therefore, a mobile device must have various iBeacon programs so as to receive advertisements from shops using different iBeacon devices, which is inconvenient for the user. Furthermore, some Bluetooth devices cannot communicate mutually unless they have been matched. However, Bluetooth matching may leak private information stored in mobile devices. Moreover, it is often too late to transmit advertisements because the distance between two Bluetooth devices may have exceeded the communication coverage before Bluetooth matching is completed

Accordingly, the present invention proposes a system and method using a wireless tire pressure detector to transmit data and form a network topology to overcome the abovementioned problems. The scheme and embodiments thereof will be described below.

### SUMMARY OF THE INVENTION

The primary objective of the present invention is to provide a system and method using a wireless tire pressure detector to transmit data and form a network topology, wherein a second transmission module of a wireless tire pressure detector, which features uninterruptible power supply and low power consumption, persistently transmits broadcast information to or receives broadcast information from nearby devices, whereby a street-parking vehicle may also function as an advertisement vehicle.

Another objective of the present invention is to provide a system and method using a wireless tire pressure detector to transmit data and form a network topology, wherein related application programs are installed in a display device receiving broadcast information from a wireless tire pressure detector, such as a mobile device or a vehicular computer, and wherein the related application programs process the broadcast information and present advertisements in sequence, whereby the display device of the user needn't match with the display devices of others, wherefore the information security is promoted.

To achieve the abovementioned objectives, the present invention proposes a method using a wireless tire pressure detector to transmit data and form a network topology, wherein wireless tire pressure detectors are respectively installed in a plurality of vehicles, and wherein while a sender transmits broadcast information, the wireless tire pressure detectors of the vehicles receive the broadcast information and retransmit the broadcast information. The method of the present invention comprises steps: at least one sender persistently transmitting at least one piece of broadcast information; while a vehicle approaches the sender, a first transmission module of a wireless tire pressure detector of the vehicle detecting and receiving the broadcast information, and sending the broadcast information to a display device in a vehicle or storing the broadcast information in a cloud database and a second transmission module; the second transmission module transmitting the broadcast information to a wireless tire pressure detector of another vehicle; the display device using an application program to process and display the broadcast information. The display device includes a video device and an audio device.

The present invention also proposes a system using a wireless tire pressure detector to transmit data and form a network topology, which comprises a sender persistently transmitting at least one piece of broadcast information; and a receiver receiving the broadcast information while approaching the sender. In the present invention, the receiver is a vehicle and includes a wireless tire pressure detector using a first transmission module to receive the broadcast information from the sender and transmit the broadcast information to a display device of the vehicle and a second transmission module; the second transmission module transmitting the broadcast information to wireless tire pressure detector of another vehicle, wherein the first transmission device is installed inside the vehicle and also receives tire pressure information from the second transmission module, and wherein the second transmission module is installed in a tire of the vehicle and also transmits tire pressure information to the first transmission module; and a display device including a video device and an audio device, using an application program to display the broadcast information, which is received by the wireless tire pressure detector, with the video device or display the broadcast information with the video device and the audio device simultaneously.

Below, embodiments are described in detail to make easily understood the objectives, technical contents, characteristics and accomplishments of the present invention.

### BRIEF DESCRIPTION OF THE DRAWINGS

FIG. 1 is a block diagram schematically showing a system using a wireless tire pressure detector to transmit data and form a network topology according to one embodiment of the present invention;

FIG. 2 shows a flowchart of a method using a wireless tire pressure detector to transmit data and form a network topology according to one embodiment of the present invention;

FIG. 3 is a diagram schematically showing that the sender is a shop according to one embodiment of the present invention;

FIG. 4 is a diagram schematically showing that the sender is another vehicle according to one embodiment of the present invention;

FIG. 5A and FIG. 5B are diagrams schematically showing that a GPS device is used to determine the distance between the current position and a shop and that the display device displays the broadcast information while the distance is smaller than a preset value according to one embodiment of the present invention.

### DETAILED DESCRIPTION OF THE INVENTION

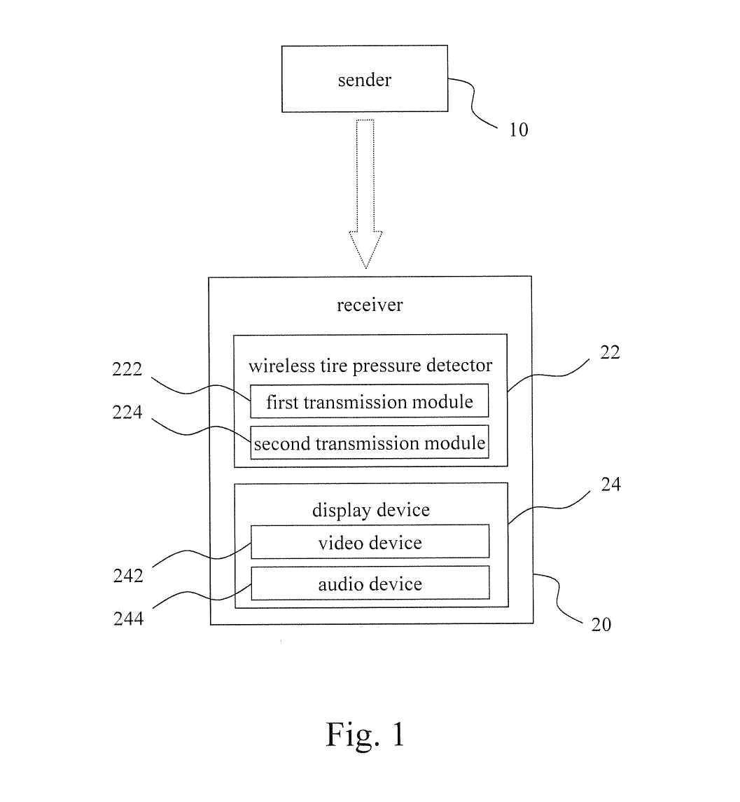

The present invention discloses a system and method using a wireless tire pressure detector to transmit data and form a network topology. Refer to FIG. 1 a block diagram schematically showing a system using a wireless tire pressure detector to transmit data and form a network topology according to one embodiment of the present invention. The system of the present invention comprises at least one sender 10 and at least one receiver 20. The sender 10 persistently transmits at least one piece of broadcast information. In the present invention, the receiver 20 is a vehicle and includes a wireless tire pressure detector 22, a first transmission module 222, a second transmission module 224 and a display device 24. The second transmission module 224 of the wireless tire pressure detector 22 is installed in a tire of the vehicle. The first transmission device 222 is installed inside the vehicle. The first transmission module 222 is realized with a Bluetooth low energy technology, receiving the broadcast information from the sender 10, storing the broadcast information in the wireless tire pressure detector 22, and transmitting the broadcast information to the display device 24 and the second transmission module 224. The second transmission module 224 is also realized with a Bluetooth low energy technology, transmitting the broadcast information of the wireless tire pressure detector 22 to a wireless tire pressure detector of another vehicle. In other words, the first transmission module 222 functions as a scanner receiving information, and the second transmission module 224 functions as a broadcaster transmitting information. The display device 24 is a mobile device or a vehicular computer and includes a video device 242 and an audio device 244. The display device 24 has an application program able to display the broadcast information received by the wireless tire pressure detector 22 with the video device 242, with the audio device 244, or with the video device 242 and the audio device 244 simultaneously.

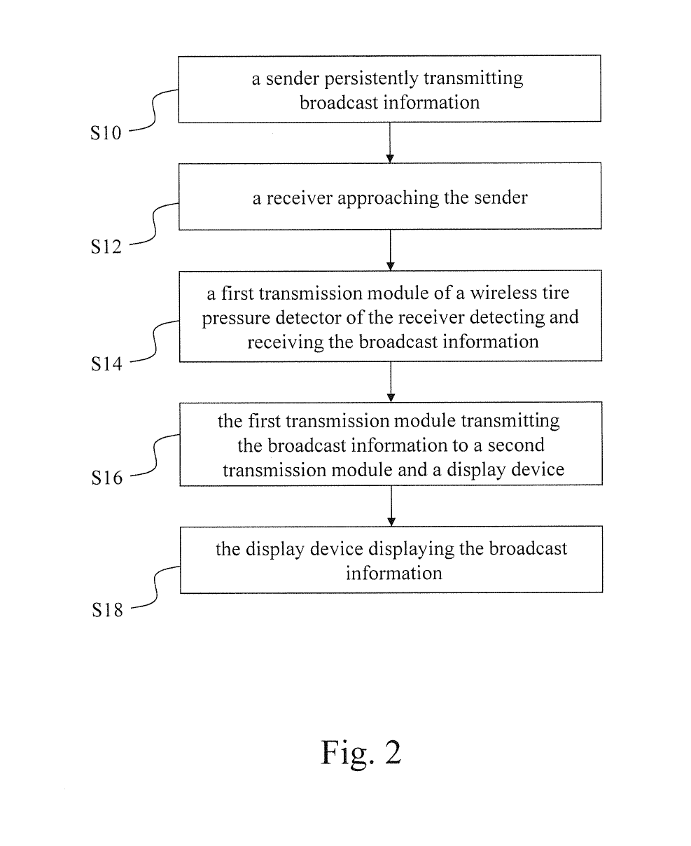

Refer to FIG. 2 a flowchart of a method using a wireless tire pressure detector to transmit data and form a network topology according to one embodiment of the present invention. In Step S10, a sender persistently transmits at least one piece of broadcast information. In Step S12, a vehicle (receiver) approaches the sender. In Step S14, a wireless tire pressure detector of the vehicle uses a first transmission module to detect and receive the broadcast information. In Step S16, the first transmission module transmits the broadcast information to a second transmission module of the wireless tire pressure detector and a display device of the vehicle. In Step S18, the display device uses an application program to display the broadcast information. The display device includes a video device and an audio device. The application program is software compatible with the wireless tire pressure detector. The firmware is installed in the wireless tire pressure detector. After the application program is installed in the display device, such as a mobile phone, a tablet computer or a vehicular computer, the display device can be linked to the wireless tire pressure detector.

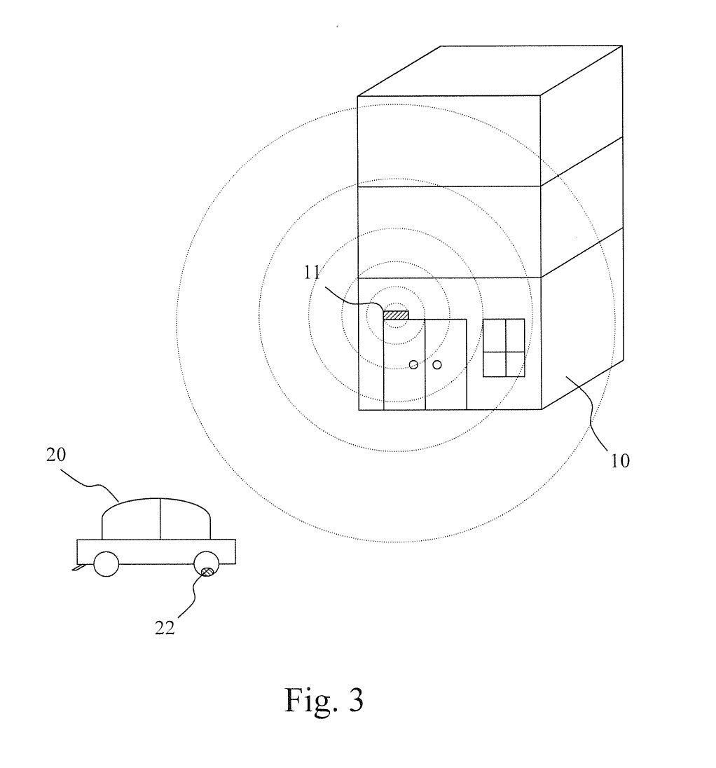

The sender may be an immobile shop or a mobile vehicle. As long as the sender is equipped with a broadcaster, the sender may be a vehicle, a shop, a person or an advertiser. Refer to FIG. 3. Suppose the sender is a shop. The broadcaster 11 of the sender 10 is a Bluetooth low energy device transmitting broadcast information to the receiver 20 passing through the region neighboring the shop. The broadcaster 11 of the shop does not receive information but only transmits broadcast information. Therefore, the broadcast information is transmitted with higher power and has coverage of as large as 50 m.

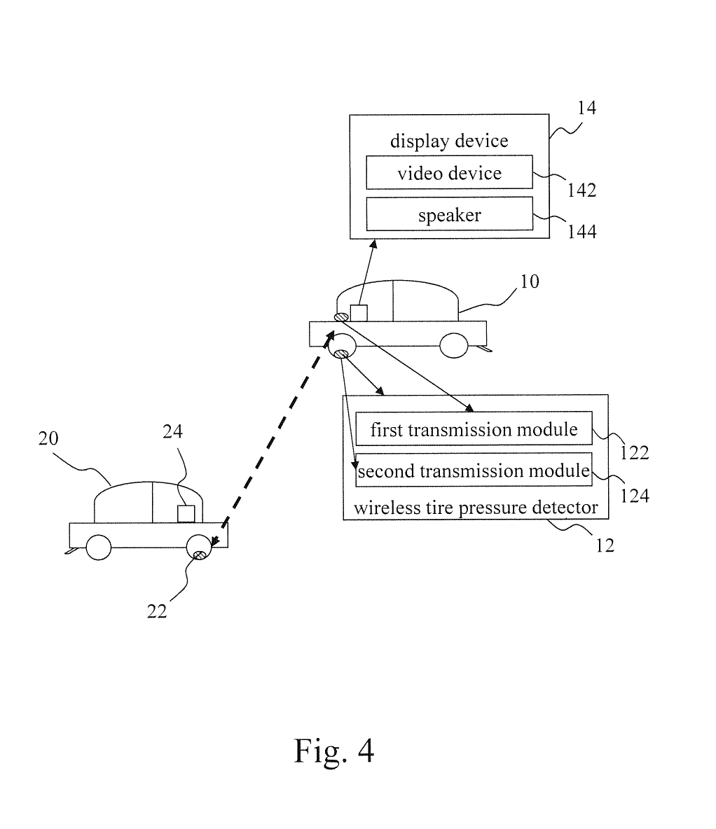

Refer to FIG. 4. If the sender 10 is a vehicle, the sender 10 is equipped with the same wireless tire pressure detector 12 as the receiver 20. The wireless tire pressure detector 12 includes a first transmission module 122 and a second transmission module 124. The second transmission module 124 transmits the broadcast information of the wireless tire pressure detector 12, and the wireless tire pressure detector 22 of the receiver 20 receives the broadcast information. The wireless tire pressure detector 12 features 24 hour uninterruptible power supply. The second transmission module 124 uses the Bluetooth low energy technology, which is free from Bluetooth matching and saves a lot of power. Therefore, the wireless tire pressure detector 12 of the sender 10 can persistently transmit signals. Even though the vehicle is on-street parked with its engine shut down, the wireless tire pressure detector 12 can still persistently transmit signals of broadcast information. Thus, the vehicle (sender 10) can function as an advertisement vehicle transmitting broadcast information to at least one receiver, just like an immobile sender (a shop).

In addition to receiving the broadcast information transmitted by a sender 10 and displaying the broadcast information with the display device 24 (a mobile phone or a vehicle computer), the receiver 20 (a vehicle) can further use the second transmission module 224 of the wireless tire pressure detector 22 to broadcast the received information. Hence, the receiver 20 can also function as a sender. Thereby, the pass-on rate and exposure rate of broadcast information is increased. Therefore, a vehicle can function as a receiver and a sender simultaneously as long as the vehicle is equipped with a wireless tire pressure detector 22 and the related application program is installed in the display device 24 thereof. The coverage of a wireless tire pressure detector 22 is 15-20 m. Vehicles can receive and transmit broadcast information mutually as long as they are appearing within the coverage.

In the present invention, the wireless tire pressure detector functions as an intermediate device between the sender and the receiver. Thus, the present invention features that the sender would not directly transmit broadcast information to the display device of the receiver. Such a feature is due to the facts: a normal sender device, such as the Bluetooth device of a mobile device, is not a Bluetooth low energy device and unable to transmit data unless Bluetooth matching is done; however, the other will learn the Bluetooth ID of the mobile device through Bluetooth matching; a mobile device usually stores a lot of personal data; information security of a mobile device will be endangered if the mobile device undertakes Bluetooth matching and then transmits data; contrarily, the Bluetooth low energy device of a wireless tire pressure detector can directly receive the signals transmitted by another Bluetooth low energy device without Bluetooth matching; therefore, no matching is needed between the sender and the receiver. Thus, the driver using the present invention can directly obtain broadcast information from his own wireless tire pressure detector without any possibility of leaking the personal data stored in his display device no matter whether the display device is a vehicular computer or a mobile device. Further, the sender of the present invention can continuously broadcast information to the region neighboring the vehicle.

In the present invention, the receiver can receive broadcast information of different data formats or from different senders, and display the broadcast information with the display device; the sender can function as a receiver as long as the sender has a wireless tire pressure detector and a first transmission module to receive information.

In one embodiment, the broadcast information includes an advertisement serial number, a positional coordinates of a shop, advertisement contents, and the duration of a special offer. In one embodiment, the receiver includes a GPS device, which is normally integrated with the display device. For example, a GPS system is built in the vehicular computer or the mobile device. In the present invention, a piece of broadcast information is not necessarily presented on the display device immediately after it is received. It may be owing to that there are too many pieces of broadcast information received. In such a case, the pieces of broadcast information will be arranged in sequence according to geographic positions, time points of receiving the broadcast information, special offer durations, and other factors. For example, a shop issuing an advertisement is located in City A; while the vehicle is in City B, the display device will not display the advertisement; while the vehicle arrives at City A, the GPS device verifies the distance between the vehicle and the positional coordinates attached to each advertisement; then, the advertisements of the shops located in City A are retrieved and arranged in the queue for display. If an advertisement is too lengthy, the advertisement may be uploaded to a cloud database beforehand with a link to the cloud database attached to the advertisement. The driver can click on the display device to link to the cloud database or a related website.

Therefore, when the receiver receives broadcast information of a shop, the system needn't display the broadcast information immediately but has an option to arrange the broadcast information in the queue of the display device. Further, the system uses the GPS device to detect the current position and the distance between the current position and the shop. The display device will not display the broadcast information unless the distance between the current position and the shop is smaller than a preset value.

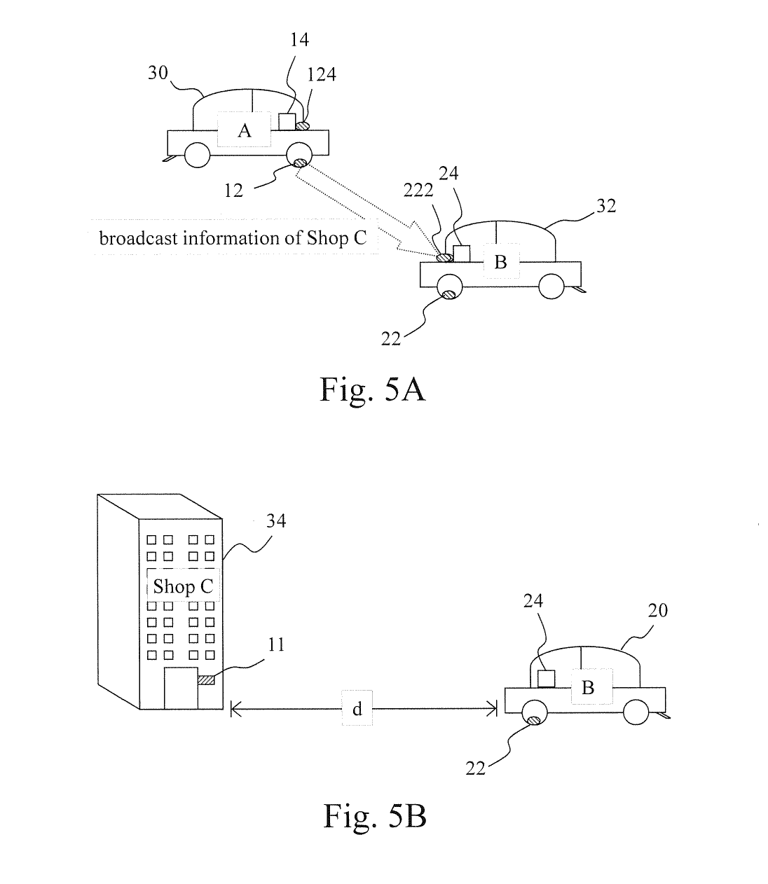

Refer to FIG. 5A and FIG. 5B diagrams schematically showing that a GPS device is used to determine the distance between the current position and a shop and that the display device displays the broadcast information while the distance is smaller than a preset value according to one embodiment of the present invention. In FIG. 5A and FIG. 5B, a vehicle 30 (Vehicle A) functions as a sender and uses a second transmission module of a wireless tire pressure detector 12 to persistently send out broadcast information of a shop 34 (Shop C). The broadcast information sent out by the vehicle 30 (Vehicle A) was received while the vehicle 30 (Vehicle A) passed by the shop 34 (Shop C) a short time ago or has been received for a long time. While a vehicle 32 (Vehicle B) passes by the vehicle 30 (Vehicle A) and the distance therebetween is within a range of 20-30 m, the first transmission module 222 of the wireless tire pressure detector 22 of the vehicle 32 (Vehicle B) receives the broadcast information of Shop C sent out by the vehicle 30 (Vehicle A). At this time, the vehicle 32 (Vehicle B) is a receiver receiving the signals sent out by the vehicle 30 (Vehicle A). The broadcast information includes the positional coordinates of the shop 34 (Shop C). Suppose that the vehicle 30 (Vehicle A) and the vehicle 32 (Vehicle B) send out signals and exchange information at a location 1 km away from the shop 34 (Shop C). While the vehicle 32 (Vehicle B) reaches a position whose distance to the shop 34 (Shop C) is d (e.g. 500 m), the broadcast information is shown on the display device 24, whereby the driver of the vehicle 32 (Vehicle B) can find a parking lot early.

In addition to persistently broadcasting information, the shop 34 (Shop C) further identifies the vehicles passing by to read the identity numbers of the first transmission modules of the vehicles (the receivers) and calculate the count of reading the identity number of each receiver so as to determine whether a receiver is a distinguished guest.

In one embodiment, the broadcast information does not include the positional coordinates of a shop but includes the serial number of the broadcast information, the identity number of the shop, the contents of the advertisement and the special offer duration. In the same embodiment, the receiver includes the lookup table of the identity numbers of shops and the positional coordinates of the shops. The receiver may be a vehicular computer or a mobile device. The receiver needn't have a GPS system. The lookup table can be downloaded from a cloud database. While a vehicle arrives at City A and receives the broadcast information of every shop, the system uses the identity numbers of the shops to look up the positional coordinates of the shops and determines the distances between the vehicle and the shops. Next, the system retrieves the advertisements of the shops in City A and arranges the advertisements in the queue for display. Then, the display device displays the advertisements in sequence.

In the same embodiment, while the receiver receives a piece of broadcast information of a shop, the system needn't display the broadcast information immediately but has an option to arrange the broadcast information in the queue of the display device. Next, the system uses the lookup table of the identity numbers of the shops and the positional coordinates of the shops to calculate the distance between the current position of the vehicle and the position of the shop of the advertisement to be displayed next. The display device will not display the advertisement of the shop until the vehicle moves to a position whose distance to the shop is smaller than a preset value, as shown in FIG. 5A and FIG. 5B.

In conclusion, the present invention proposes a system and method using a wireless tire pressure detector to transmit data and form a network topology, wherein a wireless tire pressure detector is equipped with a Bluetooth module including a first transmission module functioning as a scanner and a second transmission module functioning as a broadcaster. Owing to low power consumption, the second transmission can persistently transmit broadcast information no matter whether the vehicle is operating or shut down. The present invention uses the wireless tire pressure detector as an intermediate repeater, thus exempting the vehicular computer or the mobile device from directly Bluetooth matching with another's device and preventing from leakage of personal data. As vehicles are moveable, reciprocal data transmission among the vehicles would form a large network topology, expand the coverage of advertisements and increase exposure of advertisements.

The embodiments described are only to exemplify the present invention but not to limit the scope of the present invention. Any equivalent modification or variation according to the characteristic or spirit of the present invention is to be also included with the scope of the present invention.

What is claimed is:

1. A method of using wireless tire pressure detectors to transmit data and form a network topology, wherein a plurality of vehicles are respectively equipped with wireless tire pressure detectors, and wherein while at least one sender transmits at least one piece of broadcast information, said vehicles use said wireless tire pressure detectors to receive said broadcast information and retransmit said broadcast information, and wherein said method comprises steps:
said sender persistently transmitting said broadcast information;
while one said vehicle approaches said sender, said wireless tire pressure detector of said vehicle using a first transmission module to detect said broadcast information and receive it, and transmits said broadcast information to a second transmission module and a display device of said vehicle; and
said vehicle using said second transmission module to retransmit said broadcast information to said wireless tire pressure detector of another said vehicle, wherein said display device uses an application program to process and display said broadcast information, and wherein said display device includes a video device and an audio device.

2. The method using a wireless tire pressure detector to transmit data and form a network topology according to claim 1, wherein said second transmission module of said wireless tire pressure detector is installed in a tire of said vehicle, and said first transmission module of said wireless tire pressure detector is installed inside said vehicle.

3. The method using a wireless tire pressure detector to transmit data and form a network topology according to claim 1, wherein said sender is a broadcaster provided by another vehicle, a shop, a person, or an advertiser.

4. The method using a wireless tire pressure detector to transmit data and form a network topology according to claim 3, wherein while said sender is said another vehicle, said broadcaster is one said wireless tire pressure detector installed in said another vehicle.

5. The method using a wireless tire pressure detector to transmit data and form a network topology according to claim 1, wherein said display device is a vehicular computer or a mobile device, which can display video and audio information.

6. The method using a wireless tire pressure detector to transmit data and form a network topology according to claim 1, wherein said broadcast information includes a serial number of an advertisement, positional coordinates of a shop, contents of said advertisement, and a special offer duration.

7. The method using a wireless tire pressure detector to transmit data and form a network topology according to claim 6 further comprising steps:
said vehicle using a GPS (Global Positioning System) device to detect a position of said vehicle and a distance between said vehicle and said shop; and
while said distance between said vehicle and said shop is smaller than a preset value, said display device displaying said broadcast information of said shop.

8. The method using a wireless tire pressure detector to transmit data and form a network topology according to claim 1, wherein said vehicle also functions as said sender and uses said second transmission module to transmit said broadcast information.

9. The method using a wireless tire pressure detector to transmit data and form a network topology according to claim 1, wherein said second transmission module still transmits said broadcast information persistently while said vehicle is shut down.

10. A system using a wireless tire pressure detector to transmit data and form a network topology, wherein a plurality of vehicles are respectively equipped with wireless tire pressure detectors, and wherein while at least one sender transmits at least one piece of broadcast information, said vehicles use said wireless tire pressure detectors to receive said broadcast information and retransmit said broadcast information, and wherein said system comprises
at least one sender persistently transmitting at least one piece of broadcast information;
at least one receiver receiving said broadcast information while approaching said sender, wherein said receiver is a vehicle including
a first transmission module installed in said vehicle and used to detect said broadcast information transmitted by said sender, and sent said broadcast information to a display device of said vehicle and a second transmission module;
said second transmission module installed in one said wireless tire pressure detector of said vehicle and transmitting said broadcast information to one said wireless tire pressure detector of another said vehicle; and
a display device including a video device and an audio device, using an application program to display said broadcast information, which is received by said wireless tire pressure detector, with said video device, with said audio device, or with said video device and said audio device.

11. The system using a wireless tire pressure detector to transmit data and form a network topology according to claim 10, wherein said sender is a broadcaster provided by another vehicle, a shop.

12. The system using a wireless tire pressure detector to transmit data and form a network topology according to claim 11, wherein while said sender is said another vehicle, said broadcaster is one said wireless tire pressure detector installed in said another vehicle.

13. The system using a wireless tire pressure detector to transmit data and form a network topology according to claim 10, wherein said display device is a vehicular computer or a mobile device, which can display video and audio information.

14. The system using a wireless tire pressure detector to transmit data and form a network topology according to claim 10, wherein said broadcast information includes a serial number of an advertisement, positional coordinates of a shop, contents of said advertisement, and a special offer duration.

15. The system using a wireless tire pressure detector to transmit data and form a network topology according to claim 14, wherein said receiver further includes a GPS (Global Positioning System) device for detecting a position of said receiver and a distance between said receiver and said shop, and wherein while said distance between said receiver and said shop is smaller than a preset value, said display device displays said broadcast information of said shop.

16. The system using a wireless tire pressure detector to transmit data and form a network topology according to claim 10, wherein said broadcast information includes a serial number of an advertisement, an identity number of a shop, contents of said advertisement, and a special offer duration.

17. The system using a wireless tire pressure detector to transmit data and form a network topology according to claim 16, wherein said receiver further includes a lookup table of said identity number of said shop and said positional coordinates of said receiver for calculating a distance between said receiver and said shop, and wherein while said distance between said receiver and said shop is smaller than a preset value, said display device displays said broadcast information of said shop.

18. The system using a wireless tire pressure detector to transmit data and form a network topology according to claim 10, wherein said vehicle functioning as said receiver also functions as said sender and uses said second transmission module to transmit said broadcast information.

19. The system using a wireless tire pressure detector to transmit data and form a network topology according to claim 10, wherein said second transmission module still transmits said broadcast information persistently while said vehicle is shut down.
